(19) United States
(12) Patent Application Publication
(10) Pub. No.: US 2008/0253011 A1
(43) Pub. Date: Oct. 16, 2008

(54) Signal Processing Device and Signal Processing Method

(75) Inventors: Hiroki Mouri, Osaka (JP); Akira Yamamoto, Osaka (JP)

Correspondence Address: STEPTOE & JOHNSON LLP, 1330 CONNECTICUT AVE., NW, WASHINGTON, DC, 20036, US

(73) Assignee: Matusuhita Electric Industrial Co., Ltd., Kadoma, Osaka (JP)

(21) Appl. No.: 10/587,080

(22) PCT Filed: Jan. 6, 2005
(86) PCT No.: PCT/JP05/00086

§ 371 Date: Jul. 21, 2006

(30) Foreign Application Priority Data
Jan. 23, 2004 (JP) 2004-015926

(51) Int. Cl. G11B 5/09

(52) U.S. Cl. 360/39

(57) ABSTRACT

There is provided a signal processing apparatus and a signal processing method, which can simultaneously perform reduction in jitter components and reduction in error rate.

A signal processing apparatus for processing a signal by a PRML method is provided with an A/D converter (4) for converting an analog signal into a digital signal; a first waveform equalizer (14) which is connected to the A/D converter (4), and amplifies a specific band of a signal to optimize data of a clock extraction system; a second waveform equalizer (15) which is connected to the A/D converter (4), and amplifies the specific band of the signal and performs waveform equalization to optimize data of a data processing system; a timing recovery logic circuit (11) which is connected to the first waveform equalizer (14), and extracts a reproduction clock; and a decoder (16) which is connected to the second waveform equalizer (15), and decodes data.

### TECHNICAL FIELD

The present invention relates to a signal processing device and a signal processing method, and more particularly, to those for accurately extracting information that is read from a recording medium such as an optical disc, a magnetic disc, or a semiconductor memory.

### BACKGROUND ART

In recent years, storage devices for recording digital information, such as optical disc storage devices, magnetic recording storage devices, and semiconductor memory storage devices, have been utilized widely, and the recording density is increasing year by year. In order to reproduce the information recorded on these recording media without errors, various kinds of signal processing techniques have been investigated to date. For example, the PRML (Partial Response Maximum Likelihood) method is well known.

In the PRML method, a signal read from a recording medium is initially subjected to removal of a signal in a specific band by an analog filter, and amplification. The reason is as follows. That is, it is necessary to remove noises as well as amplify a signal in a specific band because an amplitude cannot be accurately obtained in reading a high-frequency signal.

FIG. 5 is a block diagram illustrating a conventional signal processing device.

As shown in FIG. 5, the conventional signal processing device comprises a recording medium 101, a variable gain amplifier (VGA) 102, a low-pass filter (LPF) 103 as an analog filter, an A/D converter 104, an auto gain controller (AGC) 105, a waveform equalizer (DEQ: digital Equalizer) 106, a baseline adjuster 107, an adaptive transversal filter (FIR: Finite Impulse Response) 108, a Viterbi decoder 109 which performs error correction using a Viterbi algorithm, an LMS (Least Mean Square) 110 which performs a least mean square processing, a timing recovery logic (TRL) 111 that is a clock generation circuit for extracting a reproduction clock corresponding to a channel clock, a D/A converter 112, and a voltage controlled oscillator (VCO) 113.

Hereinafter, the operation will be described.

A signal read from the recording medium 101 is adjusted so as to have a desired degree of amplitude by the variable gain amplifier 102 and the auto gain controller 105, and then high-frequency noise of the signal is removed by the low-pass filter 103. The signal from which the high-frequency noise is removed by the low-pass filter 103 is converted into a digital signal by the A/D converter 104, and a specific band of the digital signal is amplified by the waveform equalizer 106. The timing of sampling at the A/D converter 104 is defined by reproduction clocks that are extracted in the timing recovery logic 111, the D/A converter 112, and the voltage controlled oscillator 113. The adaptive transversal filter 108 performs PR (Partial Response) waveform equalization to the signal that is amplified by the waveform equalizer 106. At this time, the IMS 110 performs a least mean square operation to derive an equalization error, and adjusts the tap coefficient of the adaptive transversal filter 108 so as to reduce the error. The PR-waveform-equalized signal is decoded by the Viterbi decoder 109 (for example, refer to Patent Document 1 (Japanese Published Patent Application No. 2003-85764)).

### DISCLOSURE OF THE INVENTION

### Problems to be Solved by the Invention

In the conventional signal processing device and signal processing method, since optimization in the time axis direction and optimization in the amplitude direction are simultaneously carried out with a single waveform equalizer, when the process of increasing the degree of amplitude is carried out to improve the sitter value, PR waveform equalization may be adversely affected by noise amplification or the like. Therefore, even when the jitter value becomes an optimized value, the error ratio cannot be reduced in proportion thereto.

The present invention is made to solve the above-mentioned problems and has for its object to provide a signal processing apparatus and a signal processing method, which can perform reduction in the jitter components and reduction in the error rate simultaneously.

### Measures to Solve the Problems

According to claim 1 of the present invention, a signal processing apparatus for processing a signal using a PRML (Partial Response Maximum Likelihood) method, comprises an A/D converter for converting an analog signal into a digital signal; a first waveform equalizer for amplifying a specific band of the signal to optimize data of a clock extraction system, the equalizer being connected to the A/D converter; a second waveform equalizer for subjecting the specific band of the signal to amplification as well as waveform equalization, thereby to optimize data of a data processing system, the equalizer being connected to the A/D converter; a timing recovery logic circuit for extracting a reproduction clock, the logic circuit being connected to the first waveform equalizer; and a decoder for decoding data, the decoder being connected to the second waveform equalizer.

According to claim 2 of the present invention, a signal processing apparatus comprises a variable gain amplifier for automatically adjusting a signal read from a recording medium so that the signal has a desired amplitude; a filter circuit for removing a signal in a specific band, the filter circuit being connected to the variable gain amplifier; an A/D converter for converting an analog signal into a digital signal, the converter being connected to the filter circuit; an adaptive transversal filter for amplifying a signal in a specific band as well as performing waveform equalization for a reproduction signal; the filter being connected to the A/D converter; an automatic gain controller being connected to the A/D converter; a waveform equalizer for performing waveform equalization, the equalizer being connected to the A/D converter; a control circuit for performing baseline control, the control circuit being connected to the waveform equalizer; a detection circuit for performing error detection and correction using a LMS (Least Mean Square) algorithm, the detection circuit being connected to the adaptive transversal filter; a decoder for performing maximum likelihood decoding, the decoder being connected to the adaptive transversal filter; and a timing recovery logic circuit for extracting a reproduction clock, the logic circuit being connected to the control circuit.

According to claim 3 of the present invention, a signal processing apparatus comprises a variable gain amplifier for automatically adjusting a signal read from a recording medium so that the signal has a desired amplitude; an A/D converter for converting an analog signal into a digital signal, the converter being connected to the variable gain amplifier; an adaptive transversal filter for amplifying a signal in a specific band as well as performing waveform equalization for a reproduction signal, the filter being connected to the A/D converter; an automatic gain controller being connected to the A/D converter; a waveform equalizer for performing waveform equalization, the equalizer being connected to the A/D converter; a control circuit for performing baseline control, the control circuit being connected to the waveform equalizer; a detection circuit for performing error detection and correction using a LMS (Least Mean Square) algorithm, the detection circuit being connected to the adaptive transversal filter; a decoder for performing maximum likelihood decoding, the decoder being connected to the adaptive transversal filter; and a timing recovery logic circuit for extracting a reproduction clock, the logic circuit being connected to the control circuit.

According to claim 4 of the present invention, in the signal processing apparatus defined in claim 2, the filer circuit is a low-pass filter which is constituted by an order equal to or lower than third order.

According to claim 5 of the present invention, in the signal processing apparatus defined in any of claims 1 to 3, the waveform equalizer comprises a filter having a variable tap coefficient value, and an amplification degree thereof can be set freely and minutely.

According to claim 6 of the present invention, in the signal processing apparatus defined in claim 1, the first waveform equalizer and the second waveform equalizer are constituted by adaptive transversal filters which subject an input signal to filter processing in accordance with an equalization coefficient.

According to claim 7 of the present invention, in the signal processing apparatus defined in any of claims 1 to 3, vertical resolution of the A/D converter is 7 bits or lower.

According to claim 8 of the present invention, in the signal processing apparatus defined in any of claims 1 to 3, the decoder is a decoding circuit using a Viterbi algorithm.

According to claim 9 of the present invention, the signal processing apparatus defined in claim 3 further includes an adjustment circuit for calculating a jitter value on the basis of an output of the waveform equalizer, which output is corrected by the baseline control circuit, and automatically adjusting the degree of amplification of the waveform equalizer on the basis of the calculated jitter value.

According to claim 10 of the present invention, in the signal processing apparatus defined in claim 2 or 3, the recording medium is an optical disc medium.

According to claim 11 of the present invention, in the signal processing apparatus defined in claim 2 or 3, the recording medium is a magnetic disc medium.

According to claim 12 of the present invention, in the signal processing apparatus defined in claim 2 or 3, the recording medium is a semiconductor memory.

According to claim 13 of the present invention, in a signal processing method for processing a signal using a PRML (Partial Response Maximum Likelihood) method, data optimization for the signal in a time axis direction and data optimization for the signal in an amplitude direction are carried out using different waveform equalizers, respectively.

### Effects of the Invention

According to the present invention, since the channel clock extraction process by the clock extraction system and the reproduction signal extraction process by the data reproduction system are separately carried out, the jitter components and the error rate can be respectively processed without mutual interference, whereby reduction in the jitter components and reduction in the error rate can be simultaneously carried out.

Further, the data in the stage previous to amplification by the digital equalizer is treated as input data to the waveform equalization path, and the path of the clock system and the path of the reproduction data equalization system are separately subjected to parallel filtering processes, whereby noise amplification that is caused by the passage of the data through the digital equalizer can be avoided. Further, since amplification of the specific band, which has conventionally been carried out using the digital equalizer, is carried out using FIR (Finite Impulse response) and LMS (Least Mean Square), both the time axis direction and the amplitude direction can be optimized.

### BRIEF DESCRIPTION OF THE DRAWINGS

FIG. 1 is a block diagram illustrating a signal processing apparatus according to a first embodiment of the present invention.

FIG. 2 is a block diagram illustrating a signal processing apparatus according to a second embodiment of the present invention.

FIG. 3 is a block diagram illustrating a signal processing apparatus according to a third embodiment of the present invention.

FIG. 4 is a block diagram illustrating a signal processing apparatus according to a fourth embodiment of the present invention.

FIG. 5 is a block diagram illustrating a conventional signal processing apparatus.

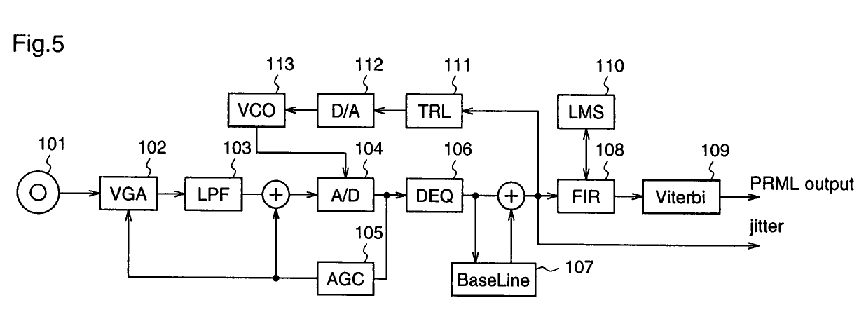

### DESCRIPTION OF REFERENCE NUMERALS

1,101 . . . recording medium

2,102 . . . variable gain amplifier

3,103 . . . low-pass filter

4,104 . . . A/D converter

5,105 . . . auto gain controller

6,106 . . . waveform equalizer

7,107 . . . baseline adjuster

8,108 . . . adaptive transversal filter

9,109 . . . Viterbi decoder

10,110 . . . LMS

11,111 . . . timing recovery logic

12,112 . . . D/A converter

13,113 . . . voltage controlled oscillator

14 . . . first waveform equalizer

15 . . . second waveform equalizer

16 . . . maximum likelihood decoder

17 . . . adjuster

### BEST MODE TO EXECUTE THE INVENTION

Hereinafter, embodiments of the present invention will be described with reference to the drawings.

### Embodiment 1

FIG. 11 is a block diagram illustrating a signal processing apparatus according to a first embodiment of the present invention.

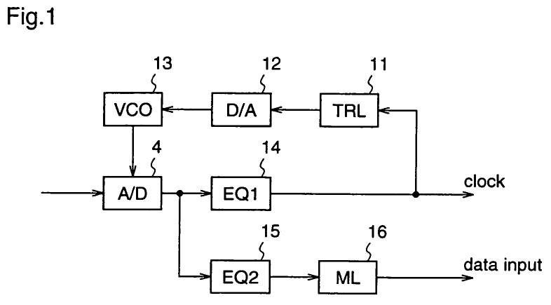

With reference to FIG. 1, the signal processing apparatus according to the first embodiment comprises an A/D converter 4, a first waveform equalizer 14, a second waveform equalizer 15, a maximum likelihood (ML) decoder 16 for performing maximum likelihood decoding, a timing recovery logic (TRL) 11 as a clock generation circuit for extracting a reproduction clock corresponding to a channel clock, and a voltage controlled oscillator (VCO) 13.

Next, a description will be given of a signal processing method in the signal processing apparatus that is constructed as described above.

The signal processing apparatus according to the first embodiment reproduces digital information by the PRML (Partial Response Maximum Likelihood) method.

A signal that is converted into a digital signal by the A/D converter 4 is amplified by the first waveform equalizer 14 with reference to a desired boost value, in a clock extraction system that performs data optimization in the time axis direction. The amplified data are inputted to the timing recovery logic 11 which is a clock generation circuit for extracting a reproduction clock corresponding to a channel clock. The timing recovery logic 11 for performing clock extraction includes a PLL (Phase Locked Loop) circuit, and generates a reproduction clock (channel clock) synchronized with a reproduction signal using the voltage controlled oscillator 13. In a data processing system as another loop, i.e., a data processing system for performing data optimization in the amplitude direction, signal amplification and waveform equalization for a specific band are carried out by the second waveform equalizer 15, and maximum likelihood decoding is carried out by the maximum likelihood decoder 16.

For example, a digital signal recorded on a DVD has a certain limitation, that is, RLL (2,10) (RLL: Run Length Limited). This means that the number of continuous “0s” existing between “1” and “1” is ten at maximum, and two at minimum. When the number of “0s” is minimum, there may occur a phenomenon that the signal amplitude is too small to read, and therefore, the signal is amplified and corrected to be waveform equalized by the first waveform equalizer 14 and the second waveform equalizer 15.

As described above, according to the first embodiment, in the clock extraction system for performing data optimization in the time axis direction and the data processing system for performing data optimization in the amplitude direction, signal amplification for a specific band, and further, waveform equalization for the specific band are performed by using the different waveform equalizers. Therefore, reduction in the jitter components and reduction in the error rate can be simultaneously carried out.

### Embodiment 2

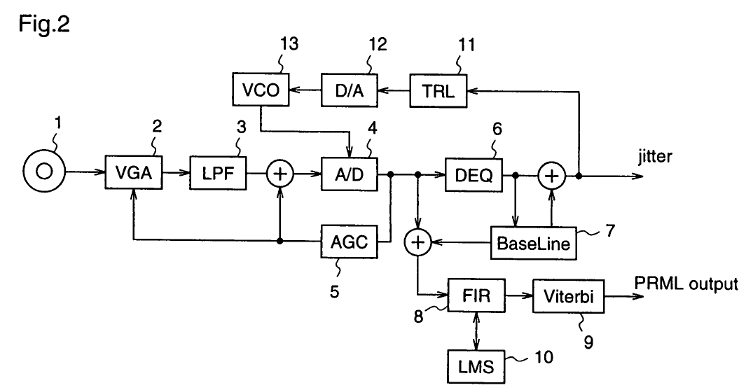

FIG. 2 is a block diagram illustrating a signal processing apparatus according to a second embodiment of the present invention.

As shown in FIG. 2, the signal processing apparatus according to the second embodiment comprises a recording medium 1 such as an optical disc media, a magnetic disc media, or a semiconductor memory, a variable gain amplifier (VGA) 2, a low-pass filter (LPF) 3 as an analog filter constituted by an order equal to or lower than third order, an A/D converter 4, an auto gain controller (AGC) 5, a waveform equalizer (DEQ: Digital Equalizer) 6 for performing signal amplification with reference to a desired boost value, a baseline adjuster 7, an adaptive transversal filter (FIR: Finite Impulse Response) 8, an LMS (Least Mean Square) 10 for performing a least mean square processing, a Viterbi decoder 9 for performing error correction using a Viterbi algorithm, a timing recovery logic (TRL) 11 which is a clock generation circuit for extracting a reproduction clock corresponding to a channel clock, a D/A converter 12, and a voltage controlled oscillator (VCO) 13.

Next, a description will be given of a signal processing method in the signal processing apparatus constructed as described above.

The signal processing apparatus according to the second embodiment reproduces digital information recorded on a recording medium using the PRML method.

A signal read from the recording medium 1 is automatically adjusted so as to have a desired degree of amplitude by the variable gain amplifier 2 and the auto gain controller 5, and then the signal is subjected to removal of high-frequency noises by the low-pass filter 3 as an analog filter, and waveform shaping. The noise-removed and waveform-shaped signal is converted into digital data with a desired vertical resolution (e.g., 7 bits or less) by the A/D converter 4.

In the clock extraction system for performing data optimization in the time axis direction, the converted digital data are amplified with reference to a desired boost value by the waveform equalizer 6. Further, the baseline adjuster 7 detects how much degree the center of the inputted signal deviates, and the DEQ output and the A/D converter output are corrected by the degree of deviation. The amplified and corrected data are input to the timing recovery logic 11 which is a clock generation circuit for extracting a reproduction clock corresponding to a channel clock. The timing recovery logic 11 for performing clock extraction includes a PLL circuit, and calculates a frequency error and a phase error to adjust the frequency and the phase, thereby generating a control signal to be applied to the voltage controlled oscillator 13. The voltage controlled oscillator 13 outputs a reproduction clock (channel clock) synchronized with the reproduction signal, on the basis of the control signal. In the data processing system as another loop, i.e., the data processing system for performing data optimization in the amplitude direction, the A/D converted output value is subjected to signal amplification for a specific band by the adaptive transversal filter 8 and the LMS 10, and the waveform-equalized signal is subjected to error correction by the Viterbi decoder 9.

As described above, according to the second embodiment, data optimization in the time axis direction is carried out using the digital equalizer output data, while data optimization in the amplitude direction is performed such that the A/D converter output data are subjected to signal amplification for a specific band by the FIR filter and the LMS. Therefore, both the time axis direction and the amplitude direction can be optimized, whereby reduction in the jitter components and reduction in the error rate can be simultaneously carried out.

### Embodiment 3

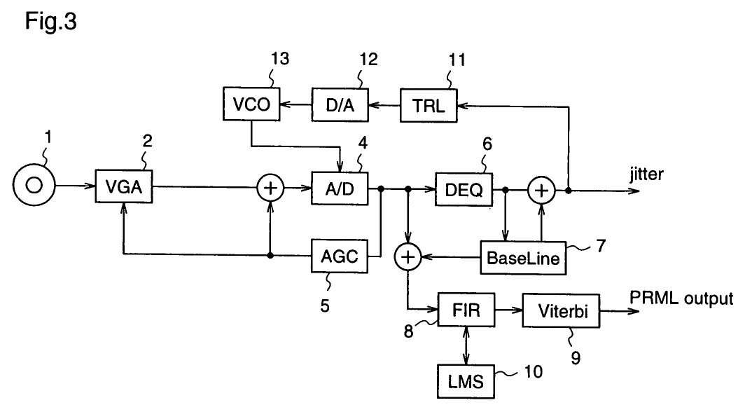

FIG. 3 is a block diagram illustrating a signal processing apparatus according to a third embodiment of the present invention.

As shown in FIG. 3, the signal processing apparatus according to the third embodiment comprises a recording medium 1 such as an optical disc media, a magnetic disc media, or a semiconductor memory, a variable gain amplifier (VGA) 2, an A/D converter 4, an auto gain controller (AGC) 5, a waveform equalizer (DEQ: Digital Equalizer) 6 for performing signal amplification with reference to a desired boost value, a baseline adjuster 7, an adaptive transversal filter (FIR: Finite Impulse Response) 8, an LMS (Least Mean Square) 10 for performing a least mean square processing, a Viterbi decoder 9 for performing error correction using a Viterbi algorithm, a timing recovery logic (TRL) 11 which is a clock generation circuit for extracting a reproduction clock corresponding to a channel clock, a D/A converter 12, and a voltage controlled oscillator (VCO) 13.

Next, a description will be given of a signal processing method in the signal processing apparatus constructed as described above.

The signal processing apparatus according to the third embodiment reproduces digital information recorded on a recording medium by the PRML method.

A signal read from the recording medium 1 is automatically adjusted so as to have a desired degree of amplitude by the variable gain amplifier 2 and the auto gain controller 5, and then it is converted into digital data with a vertical resolution of 7 bits or less by the A/D converter 4.

In the clock extraction system for performing data optimization in the time axis direction, the converted digital data are amplified with reference to a desired boost value by the waveform equalizer 6. Further, the baseline adjuster 7 detects how much degree the center of the inputted signal deviates, and the DEQ output and the A/D converter output are corrected by the degree of deviation. The amplified and corrected data are input to the timing recovery logic 11 which is a clock generation circuit for extracting a reproduction clock corresponding to a channel clock. The timing recovery logic 11 for performing clock extraction includes a PLL circuit, and calculates a frequency error and a phase error to adjust the frequency and the phase, thereby generating a control signal to be applied to the voltage controlled oscillator 13. The voltage controlled oscillator 13 outputs a reproduction clock (channel clock) synchronized with the reproduction signal, on the basis of the control signal. In the data processing system as another loop, i.e., the data processing system for performing data optimization in the amplitude direction, the A/D converted output value is subjected to signal amplification for a specific band by the adaptive transversal filter 8 and the LMS 10, and the waveform-equalized signal is subjected to error correction by the Viterbi decoder 9.

As described above, according to the third embodiment, data optimization in the time axis direction is carried out using the digital equalizer output data, while data optimization in the amplitude direction is performed such that the A/D converter output data are subjected to signal amplification for a specific band by the FIR filter and the LMS. Therefore, both the time axis direction and the amplitude direction can be optimized, whereby reduction in the jitter components and reduction in the error rate can be simultaneously carried out.

Further, since conversion into digital data is carried out with the low vertical resolution in the A/D converter 4, a low-pass filter (LPF) for removing high-frequency noises is dispensed with, resulting in a reduction in the circuit scale.

### Embodiment 4

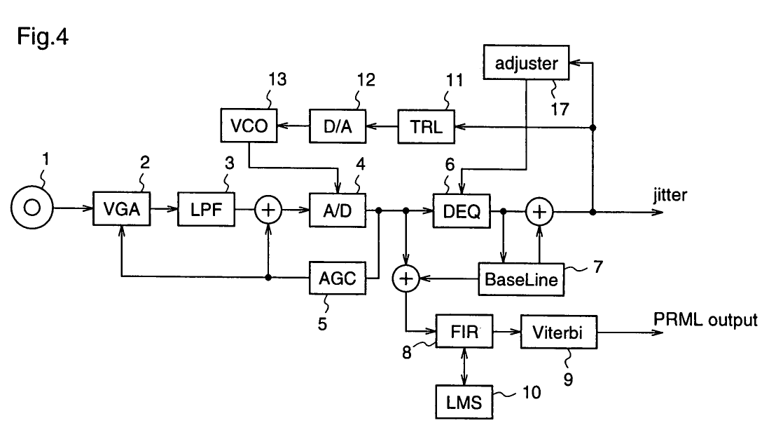

FIG. 4 is a block diagram illustrating a signal processing apparatus according to a fourth embodiment of the present invention.

With reference to FIG. 4, the signal processing apparatus according to the fourth embodiment comprises a recording medium 1 such as an optical disc media, a magnetic disc media, or a semiconductor memory, a variable gain amplifier (VGA) 2, a low-pass filter (LPF) 3 as an analog filter constituted by an order equal to or lower than third order, an A/D converter 4, an auto gain controller (AGC) 5, a waveform equalizer (DEQ: Digital Equalizer) 6 for performing signal amplification with reference to a desired boost value, a baseline adjuster 7, an adaptive transversal filter (FIR: Finite Impulse Response) 8, an LMS (Least Mean Square) 10 for performing a least mean square processing, a Viterbi decoder 9 for performing error correction using a Viterbi algorithm, a timing recovery logic (TRL) 11 which is a clock generation circuit for extracting a reproduction clock corresponding to a channel clock, a D/A converter 12, a voltage controlled oscillator (VCO) 13, and an adjuster 17 for updating the tap coefficient of the waveform equalizer 6 with reference to tap coefficient values stored in a table that is prepared in a memory or the like (not shown).

Next, a description will be given of a signal processing method in the signal processing apparatus constructed as described above.

The signal processing apparatus according to the fourth embodiment reproduces digital information recorded on a recording medium using the PRML method.

A signal read from the recording medium 1 is automatically adjusted so as to have a desired degree of amplitude by the variable gain amplifier 2 and the auto gain controller 5, and then the signal is subjected to removal of high-frequency noises by the low-pass filter 3 as an analog filter, and waveform shaping. The noise-removed and waveform-shaped signal is converted into digital data with a desired vertical resolution (e.g., 7 bits or less) by the A/D converter 4.

In the clock extraction system for performing data optimization in the time axis direction, the converted digital data are amplified with reference to a desired boost value by the waveform equalizer 6. Further, the baseline adjuster 7 detects how much degree the center of the inputted signal deviates, and the DEQ output and the A/D converter output are corrected by the degree of deviation. The amplified and corrected data are input to the timing recovery logic 11 which is a clock generation circuit for extracting a reproduction clock corresponding to a channel clock. The adjuster 17 calculates a jitter value on the basis of the DEQ output that is corrected by the baseline adjuster 7, and automatically updates the tap coefficient of the waveform equalizer 6 so as to minimize the jitter value. Since the tap coefficient values of the waveform equalizer 6 are stored in a table prepared in a memory or the like, the table is referred to. Further, the output value of the waveform equalizer 6 is also input to the timing recovery logic 11 which is a clock generation circuit for extracting a reproduction clock corresponding to a channel clock on the basis of the amplified and corrected data. The timing recovery logic 11 for performing clock extraction includes a PLL circuit, and calculates a frequency error and a phase error to adjust the frequency and the phase, thereby generating a control signal to be applied to the voltage controlled oscillator 13. The voltage controlled oscillator 13 outputs a reproduction clock (channel clock) synchronized with the reproduction signal, on the basis of the control signal. In the data processing system as another loop, i.e., the data processing system for performing data optimization in the amplitude direction, the A/D converted output value is subjected to signal amplification for a specific band by the adaptive transversal filter 8 and the LMS 10, and the waveform-equalized signal is subjected to error correction by the Viterbi decoder 9.

As described above, according to the fourth embodiment, data optimization in the time axis direction is carried out using the digital equalizer output data while data optimization in the amplitude direction is carried out such that the A/D converter output data are subjected to signal amplification for a specific band by the FIR filter and the LMS. Therefore, both the data in the time axis direction and the data in the amplitude direction can be optimized, whereby reduction in the jitter components and reduction in the error rate can be simultaneously carried out.

Further, the adjuster 17 calculates the jitter value on the basis of the DEQ output that is corrected by the baseline adjuster 7, and automatically updates the tap coefficient of the waveform equalizer 6 so as to minimize the jitter value. Therefore, the jitter component can be reduced to accurately extract a channel clock.

### APPLICABILITY IN INDUSTRY

A signal processing apparatus and a signal processing method according to the present invention can perform reduction in jitter component and reduction in error rate simultaneously, and therefore, it is useful as a reproduction apparatus for a DVD or the like. Further, it is also applicable to a magnetic recording apparatus or a semiconductor memory.

1. A signal processing apparatus for processing a signal using a PRML (Partial Response Maximum Likelihood) method, comprising:
an A/D converter for converting an analog signal into a digital signal;
a first waveform equalizer for amplifying a specific band of the signal to optimize data of a clock extraction system, said equalizer being connected to the AID converter;
a second waveform equalizer for subjecting the specific band of the signal to amplification as well as waveform equalization, thereby to optimize data of a data processing system, said equalizer being connected to the A/D converter;
a timing recovery logic circuit for extracting a reproduction clock, said logic circuit being connected to the first waveform equalizer; and
a decoder for decoding data, said decoder being connected to the second waveform equalizer.

2. A signal processing apparatus comprising:
a variable gain amplifier for automatically adjusting a signal read from a recording medium so that the signal has a desired amplitude;
a filter circuit for removing a signal in a specific band, said filter circuit being connected to the variable gain amplifier;
an A/D converter for converting an analog signal into a digital signal, said converter being connected to the filter circuit;
an automatic gain controller being connected to the A/D converter;
a waveform equalizer for performing waveform equalization, said equalizer being connected to the A/D converter;
a control circuit for performing baseline control for the output of the waveform equalizer and the output of the A/D converter on the basis of the output of the waveform equalizer;
an adaptive transversal filter for amplifying a signal in a specific band as well as performing waveform equalization for a reproduction signal, said filter being connected to the output of the A/D converter that is baseline-controlled,
a detection circuit for performing error detection and correction using a LMS (Least Mean Square) algorithm, said detection circuit being connected to the adaptive transversal filter;
a decoder for performing maximum likelihood decoding, said decoder being connected to the adaptive transversal filter; and
a timing recovery logic circuit for extracting a reproduction clock, said logic circuit being connected to the control circuit.

3. A signal processing apparatus comprising:
a variable gain amplifier for automatically adjusting a signal read from a recording medium so that the signal has a desired amplitude;
an A/D converter for converting an analog signal into a digital signal, said converter being connected to the variable gain amplifier,
an automatic gain controller being connected to the A/D converter;
a waveform equalizer for performing waveform equalization, said equalizer being connected to the A/D converter;
a control circuit for performing baseline control for the output of the waveform equalizer and the output of the A/D converter on the basis of the output of the waveform equalizer;
an adaptive transversal filter for amplifying a signal in a specific band as well as performing waveform equalization for a reproduction signal, said filter being connected to the output of the A/D converter that is baseline-controlled;
a detection circuit for performing error detection and correction using a LMS (Least Mean Square) algorithm, said detection circuit being connected to the adaptive transversal filter;
a decoder for performing maximum likelihood decoding, said decoder being connected to the adaptive transversal filter; and
a timing recovery logic circuit for extracting a reproduction clock, said logic circuit being connected to the control circuit.

4. A signal processing apparatus as defined in claim 2 wherein
said filer circuit is a low-pass filter which is constituted by an order equal to or lower than third order.

5. A signal processing apparatus as defined in claim 1
said waveform equalizer comprises a filter having a variable tap coefficient value, and an amplification degree thereof can be set freely and minutely.

6. A signal processing apparatus as defined in claim 1 wherein
said first waveform equalizer and said second waveform equalizer are constituted by adaptive transversal filters which subject an input signal to filter processing in accordance with an equalization coefficient.

7. A signal processing apparatus as defined in claim 1
vertical resolution of the A/D converter is 7 bits or lower.

8. A signal processing apparatus as defined in claim 1 wherein
said decoder is a decoding circuit using a Viterbi algorithm.

9. A signal processing apparatus as defined in claim 3 further including
an adjustment circuit for calculating a jitter value on the basis of an output of the waveform equalizer, which output is corrected by the baseline control circuit, and automatically adjusting the degree of amplification of the waveform equalizer on the basis of the calculated jitter value.

10. A signal processing apparatus as defined in claim 2 wherein said recording medium is an optical disc medium.

11. A signal processing apparatus as defined in claim 2 wherein said recording medium is a magnetic disc medium.

12. A signal processing apparatus as defined in claim 2 wherein said recording medium is a semiconductor memory.

13. A signal processing method for processing a signal using a PRML (Partial Response Maximum Likelihood) method wherein
data optimization for the signal in a time axis direction and data optimization for the signal in an amplitude direction are carried out using different waveform equalizers, respectively and baseline control is carried out during equalization by the waveform equalizers.

14. A signal processing apparatus as defined in claim 2 wherein
said waveform equalizer comprises a filter having a variable tap coefficient value, and an amplification degree thereof can be set freely and minutely.

15. A signal processing apparatus as defined in claim 3 wherein
said waveform equalizer comprises a filter having a variable tap coefficient value, and an amplification degree thereof can be set freely and minutely.

16. A signal processing apparatus as defined in claim 2 wherein
vertical resolution of the A/D converter is 7 bits or lower.

17. A signal processing apparatus as defined in claim 3 wherein
vertical resolution of the A/D converter is 7 bits or lower.

18. A signal processing apparatus as defined in claim 2 wherein
said decoder is a decoding circuit using a Viterbi algorithm.

19. A signal processing apparatus as defined in claim 3 wherein
said decoder is a decoding circuit using a Viterbi algorithm.

20. A signal processing apparatus as defined in claim 3 wherein
said recording medium is an optical disc medium.

21. A signal processing apparatus as defined in claim 3 wherein
said recording medium is a magnetic disc medium.

22. A signal processing apparatus as defined in claim 3 wherein
said recording medium is a semiconductor memory.
